(19) United States
(12) Patent Application Publication
(10) Pub. No.: US 2026/0158878 A1
(43) Pub. Date: Jun. 11, 2026

(54) AIR CONDITIONER INCLUDING A COOLANT BLOCK

(71) Applicants: HYUNDAI MOTOR COMPANY, Seoul (KR); KIA CORPORATION, Seoul (KR); DOOWON HEAVY INDUSTRIAL CO., LTD., Sacheon-si (KR)

(72) Inventors: Yeong Jun Kim, Hwaseong-si (KR); Hochan An, Hwaseong-si (KR); Yeon Ho Kim, Hwaseong-si (KR); Jeawan Kim, Hwaseong-si (KR); Gwi Taek Kim, Hwaseong-si (KR); Man Hee Park, Hwaseong-si (KR); Jae Yeon Kim, Hwaseong-si (KR); Hoyoung Jeong, Hwaseong-si (KR); Yun Ki Kwon, Seoul (KR); Tea Jin Lee, Pyeongtaek-si (KR); In Pyo Bae, Yongin-si (KR); Yong Seon Park, Pyeongtaek-si (KR)

(73) Assignees: HYUNDAI MOTOR COMPANY, Seoul (KR); KIA CORPORATION, Seoul (KR); DOOWON HEAVY INDUSTRIAL CO., LTD., Sacheon-si (KR)

(21) Appl. No.: 19/221,032

(22) Filed: May 28, 2025

(30) Foreign Application Priority Data
Dec. 9, 2024 (KR) 10-2024-0181541

(51) Int. Cl. B60H 1/32; B60H 1/00

(52) U.S. Cl. CPC B60H 1/3229; B60H 1/00321; B60H 1/3228

(57) ABSTRACT

A coolant block of an air conditioner includes a block housing, and a first coolant chamber and a second coolant chamber formed in the block housing. The second coolant chamber is disposed adjacent to the first coolant chamber. The coolant block includes a first inflow flow path and a first discharge flow path formed in the block housing and fluidly connected to the first coolant chamber. The coolant block further includes a second inflow flow path and a second discharge flow path formed in the block housing and fluidly connected to the second coolant chamber. The coolant block also includes an expansion valve provided in the block housing and fluidly connected to the first discharge flow path, an expansion flow path formed in the block housing through which a coolant expanded in the expansion valve flows, and a connection flow path formed in the block housing that fluidly connects a compressor and a condenser.

### CROSS-REFERENCE TO RELATED APPLICATION

This application claims priority to and the benefit of Korean Patent Application No. 10-2024-0181541 filed with the Korean Intellectual Property Office on Dec. 9, 2024, the entire contents of which are incorporated herein by reference.

### BACKGROUND

### Technical Field

The present disclosure relates to an air conditioner including a coolant block, and more particularly, to an air conditioner including a coolant block capable of minimizing loss of a coolant circulating in the air conditioner.

### Description of the Related Art

In general, an air conditioning system for a vehicle includes an air conditioner that circulates a coolant to heat or cool the inside of the vehicle.

The air conditioner maintains a comfortable indoor environment by maintaining an appropriate temperature inside the vehicle regardless of an external temperature change. The air conditioner is configured to heat or cool the inside of the vehicle through heat exchange by an evaporator. In this process, a coolant discharged by driving of a compressor is circulated back to the compressor through a condenser, a receiver dryer, an expansion valve, and the evaporator.

In other words, when the air conditioner is in a cooling mode in the summer, a high-temperature and high-pressure gaseous coolant compressed by the compressor is condensed through the condenser and then passes through the receiver dryer and the expansion valve to evaporate in the evaporator. Once this process is done, a temperature and humidity of the interior of the vehicle are lowered.

When the air conditioner is installed in the vehicle, each component of the air conditioner is connected through a pipe, and a lot of pressure loss occurs as the coolant passes through the pipe. Pressure loss of the coolant may cause energy loss of the coolant, and, as a result, cooling and heating performance of the air conditioner is deteriorated.

The above information disclosed in this Background section is only for enhancement of understanding of the background of this disclosure. Therefore, the Background section may include information that does not form the prior art that is already known to a person of ordinary skill in the art.

### SUMMARY

An aspect of the present disclosure is to provide an air conditioner including a coolant block capable of minimizing loss of a coolant caused by a pipe through which the coolant flows in the air conditioner.

Technical problems to be solved by the present disclosure are not limited to the above-mentioned technical problems, and other technical problems, which are not mentioned above, may be clearly understood from the following descriptions by those having ordinary skill in the art to which the present disclosure pertains.

The present disclosure has been made in an effort to solve the above-described problems associated with the prior art. The present disclosure provides an air conditioner including a coolant block. The coolant block includes a block housing, a first coolant chamber formed in the block housing, and a second coolant chamber formed in the block housing and disposed adjacent to the first coolant chamber. The coolant block further includes a first inflow flow path formed in the block housing and fluidly connected to the first coolant chamber, a first discharge flow path formed in the block housing and fluidly connected to the first coolant chamber, a second inflow flow path formed in the block housing and fluidly connected to the second coolant chamber, and a second discharge flow path formed in the block housing and fluidly connected to the second coolant chamber. The coolant block further includes an expansion valve provided in the block housing and fluidly connected to the first discharge flow path, an expansion flow path formed in the block housing through which a gaseous coolant expanded in the expansion valve flows, and a connection flow path formed in the block housing fluidly connecting a compressor and a condenser.

In an embodiment, an inlet of the connection flow path and an outlet of the second discharge flow path may be formed on a first surface of the block housing, an outlet of the expansion flow path and an inlet of the second inflow flow path may be formed on a second surface of the block housing, and an inlet of the first inflow flow path and an outlet of the connection flow path may be formed on a third surface of the block housing.

In an embodiment, the air conditioner may further include the compressor fluidly connected to the inlet of the connection flow path and the outlet of the second discharge flow path. The compressor may be provided on the first surface of the block housing.

In an embodiment, the air conditioner may further include the condenser fluidly connected to the inlet of the first inflow flow path and the outlet of the connection flow path. The condenser may be provided on the third surface of the block housing.

In an embodiment, the air conditioner may further include an evaporator fluidly connected to the outlet of the expansion flow path and the inlet of the second inflow flow path. The evaporator may be provided on the second surface of the block housing.

In an embodiment, a coolant stored in the first coolant chamber may be heat-exchanged with a low-temperature coolant flowing through the second coolant chamber. The coolant may separate into the gaseous coolant and a liquid coolant, and the first coolant chamber may function as a receiver dryer that supplies only the liquid coolant to the expansion valve.

In an embodiment, the air conditioner may further include a first partition wall that divides the first coolant chamber and a communication hole formed in the first partition wall.

In an embodiment, the first coolant chamber and the second coolant chamber may be divided by a second partition wall.

In an embodiment, a cross-section of the second partition wall may be formed in a zigzag shape.

In an embodiment, the air conditioner may further include a first cover that covers an open surface of the first coolant chamber and a second cover that covers an open surface of the second coolant chamber.

In an embodiment, the air conditioner may further include a first O-ring provided between the first cover and the block housing and a second O-ring provided between the second cover and the block housing.

In an embodiment, an inlet of the connection flow path and an outlet of the first discharge flow path may be formed on a first surface of the block housing. An outlet of the connection flow path and an inlet of the second inflow flow path may be formed on a second surface of the block housing. Further, an outlet of the expansion flow path and an inlet of the first inflow flow path may be formed on a third surface of the block housing.

In an embodiment, the air conditioner may further include the compressor fluidly connected to the inlet of the connection flow path and the outlet of the first discharge flow path. The compressor may be provided on the first surface of the block housing.

In an embodiment, the air conditioner may further include the condenser fluidly connected to the outlet of the connection flow path and the inlet of the second inflow flow path. The condenser may be provided on the second surface of the block housing.

In an embodiment, the air conditioner may further include an evaporator that is fluidly connected to the outlet of the expansion flow path and the inlet of the first inflow flow path and is provided on the third surface of the block housing.

In an embodiment, a coolant stored in the first coolant chamber may be heat-exchanged with a high-temperature coolant flowing through the second coolant chamber. The coolant may separate into the gaseous coolant and a liquid coolant, and the first coolant chamber may function as an accumulator that supplies only the gaseous coolant to the compressor.

A coolant block of an air conditioner is further provided. The coolant block includes a block housing, and a first coolant chamber and a second coolant chamber formed in the block housing. The second coolant chamber is disposed adjacent to the first coolant chamber. The coolant block further includes a first inflow flow path and a first discharge flow path formed in the block housing and fluidly connected to the first coolant chamber, and a second inflow flow path and second discharge flow path formed in the block housing and fluidly connected to the second coolant chamber. The coolant block further includes an expansion valve provided in the block housing and fluidly connected to the first discharge flow path, an expansion flow path formed in the block housing through which a gaseous coolant expanded in the expansion valve flows, and a connection flow path formed in the block housing that fluidly connects a compressor and a condenser. The coolant block also includes an evaporator formed in the block housing and fluidly connected to an inlet of the connection flow path and an outlet of the second discharge flow path.

In an embodiment, the compressor, the condenser, the expansion valve, and the evaporator are sequentially disposed along a flow direction of a coolant.

In an embodiment, a coolant discharged by driving of the compressor is circulated back to the compressor through the condenser, the expansion valve, and the evaporator.

In an embodiment, heat exchange between the coolant and an indoor air of a vehicle is performed through the evaporator so that the air conditioner cools the inside of the vehicle.

According to the embodiments, a compressor, a condenser, and an evaporator included in an air conditioner may be fluidly directly connected through a coolant block so that it is possible to minimize loss of the coolant in a process of circulating the coolant.

In addition, the number of assembly processes of assembling the air conditioner may be reduced so that workability is improved, and a production cost is reduced.

In addition, an effect obtained or predicted by an embodiment of the present disclosure is disclosed directly or implicitly in a detailed description of the present disclosure. In other words, various effects predicted according to the present disclosure are disclosed in the detailed description below.

### BRIEF DESCRIPTION OF THE DRAWINGS

The drawings are for reference only in describing embodiments of the present disclosure, and therefore the technical idea of the present disclosure should not be limited to the accompanying drawings.

FIG. 1 is a circuit diagram showing a configuration of an air conditioner to which a coolant block is applied according to an embodiment of the present disclosure.

FIG. 2 is a perspective view showing the configuration of the air conditioner to which the coolant block is applied according to an embodiment of the present disclosure.

FIG. 3 is an exploded perspective view showing the configuration of the air conditioner to which the coolant block is applied according to an embodiment of the present disclosure.

FIG. 4 is a perspective view showing a configuration of the coolant block according to an embodiment of the present disclosure.

FIG. 5 is a cross-sectional view of the coolant block according to an embodiment of the present disclosure.

FIG. 6 is a circuit diagram showing a configuration of an air conditioner to which a coolant block is applied according to another embodiment of the present disclosure.

FIG. 7 is a perspective view showing a configuration of the coolant block according to another embodiment of the present disclosure.

The drawings referenced above are not necessarily to scale, but should be understood as providing a somewhat simplified representation of various features that illustrate a basic principle of the present disclosure. For example, specific design features of the present disclosure including a specific dimension, a direction, a position, and a shape will be determined in part by the particular intended application and use environment.

### DETAILED DESCRIPTION

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprises” and/or “comprising” when used in this specification specify the presence of stated features, integers, steps, operations, elements, and/or components but do not preclude the presence or addition of one or more other features, integers, steps, operations, elements, components, and/or groups thereof. As used herein, the term “and/or” includes any one or all combinations of associated listed items.

With reference to the accompanying drawings, the present disclosure is described in detail so that a person with ordinary skill in the art to which the present disclosure belongs may easily practice the present disclosure. However, the present disclosure may be implemented in many different forms and is not limited to the embodiments described herein.

In order to clearly describe the present disclosure, parts or portions that are irrelevant to the description are omitted, and identical or similar constituent elements throughout the specification are denoted by the same reference numerals.

In the drawings, a size and a thickness of each element are arbitrarily illustrated for ease of description so that the present disclosure is not necessarily limited to what is illustrated in the drawings. In the drawings, the thicknesses of some portions and areas are exaggerated for clarity.

Spatially relative terms, such as “beneath,” “below,” “lower,” “under,” “above,” “upper,” “side” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

The suffixes “module” and “portion” of an element are used for convenience of description to be interchangeably used and do not have any distinguishable meanings or roles.

In addition, in describing an embodiment disclosed in the present specification, when it is determined that a detailed description of a related known technology may obscure gist of the embodiment disclosed in the present specification, the detailed description thereof is omitted.

In addition, the accompanying drawings are only intended to facilitate easy understanding of the embodiments disclosed in this specification, and a technical idea disclosed in this specification is not limited by the accompanying drawings and should be understood to include all modifications, equivalents, or substitutes included in an idea and a technical scope of the present disclosure.

Terms including ordinal numbers such as first and second may be used to describe various elements, but the elements are not limited by the terms.

In the description below, a term described in singular may be interpreted as singular or plural unless an explicit term such as “one” or “single” is used.

Terms are used only for the purpose of distinguishing one element from another element.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Hereinafter, an air conditioner according to an embodiment is described in detail with reference to the accompanying drawings.

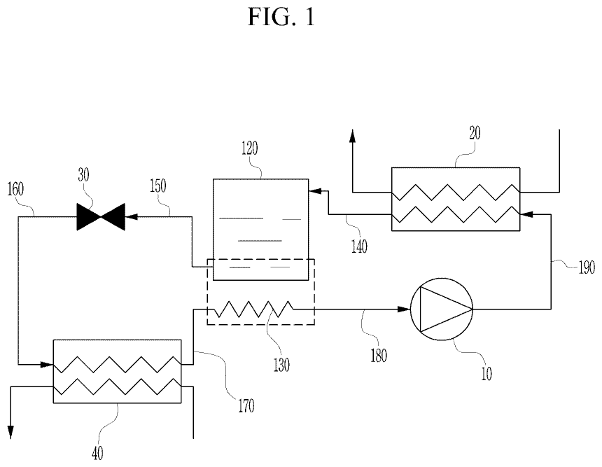

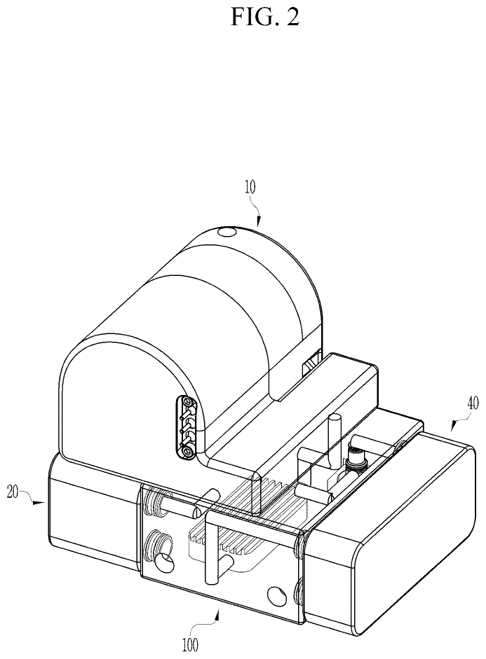

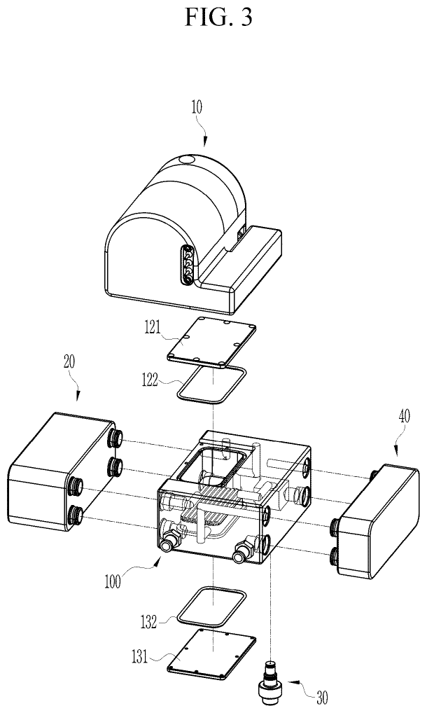

FIG. 1 is a circuit diagram showing a configuration of an air conditioner to which a coolant block is applied according to an embodiment. FIG. 2 is a perspective view showing the configuration of the air conditioner to which the coolant block is applied according to an embodiment. FIG. 3 is an exploded perspective view showing the configuration of the air conditioner to which the coolant block is applied according to an embodiment.

As shown in FIGS. 1-3, in the air conditioner according to an embodiment, a compressor 10, a condenser 20, an expansion valve 30, and an evaporator 40 may be sequentially disposed along a flow direction of a coolant. A coolant discharged by driving of the compressor 10 may be circulated back to the compressor 10 through the condenser 20, the expansion valve 30, and the evaporator 40. In this process, heat exchange between the coolant and indoor air of a vehicle may be performed through the evaporator 40 so that the air conditioner cools the inside of the vehicle. In other words, in the air conditioner, a high-temperature and high-pressure gaseous coolant compressed by the compressor 10 may be condensed through the condenser 20 and then may pass through an expansion device to evaporate in the evaporator 40 to lower a temperature and humidity of the interior of the vehicle.

In the air conditioner according to an embodiment, the compressor 10, the condenser 20, the expansion valve 30, and the evaporator 40 may be fluidly connected around a coolant block 100. In other words, the air conditioner may include the coolant block 100, the compressor 10 fluidly connected to the coolant block 100, the condenser 20 fluidly connected to the coolant block 100, the expansion valve 30 fluidly connected to the coolant block 100, and the evaporator 40 fluidly connected to the coolant block 100.

Because the compressor 10, the condenser 20, the expansion valve 30, and the evaporator 40 are fluidly connected through the coolant block 100, it is possible to minimize loss of the coolant by circulating the coolant through the compressor 10, the condenser 20, the expansion valve 30, and the evaporator 40.

In addition, because the compressor 10, the condenser 20, the expansion valve 30, and the evaporator 40 are assembled through the coolant block 100, the number of assembly processes may be reduced, so that workability is improved, and production cost is reduced.

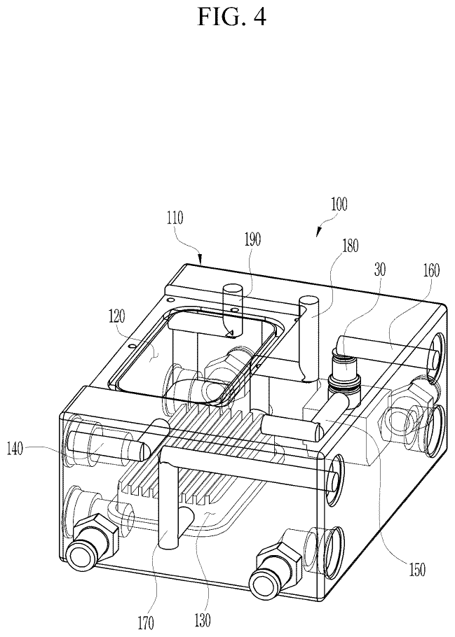

FIG. 4 is a perspective view showing a configuration of the coolant block according to an embodiment.

Referring to FIG. 4, the coolant block 100 according to an embodiment may include a block housing 110, a first coolant chamber 120 and a second coolant chamber 130 formed in the block housing 110, and a plurality of flow paths formed in the block housing 110.

The block housing 110 may be formed in an approximately hexahedral shape, and the first coolant chamber 120, the second coolant chamber 130, and the plurality of flow paths may be formed inside the block housing 110.

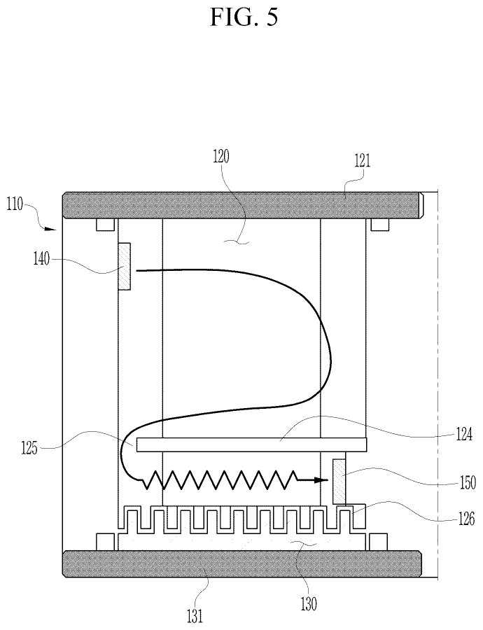

A first coolant chamber 120 may be formed in the block housing 110, and an upper portion of the first coolant chamber 120 may be opened. The first coolant chamber 120 may be formed at an upper portion of the block housing 110, and the opened upper portion of the first coolant chamber 120 may be closed by a first cover 121 (see FIGS. 3 and 5). In other words, the first cover 121 may cover an open surface of the first coolant chamber 120. The first coolant chamber 120 may be formed as a sealed space by the first cover 121.

If necessary, as shown in FIG. 3, a first O-ring 122 may be provided between the first cover 121 and the block housing 110. The coolant flowing into the first coolant chamber 120 may be prevented from leaking to the outside by the first O-ring 122.

A second coolant chamber 130 may be formed in the block housing 110, may be disposed adjacent to the first coolant chamber 120, and a lower portion of the second coolant chamber 130 may be opened. The second coolant chamber 130 may be formed at a lower portion of the block housing 110, and an opened lower portion of the second coolant chamber 130 may be closed by a second cover 131 (see FIGS. 3 and 5). In other words, the second cover 131 may cover an open surface of the second coolant chamber 130. The second coolant chamber 130 may be formed as a sealed space by the second cover 131. In the example shown in FIG. 4, the first coolant chamber 120 and the second coolant chamber 130 are disposed on opposite sides or surfaces of the block housing 110.

If necessary, as shown in FIG. 3, a second O-ring 132 may be provided between the second cover 131 and the block housing 110. The coolant flowing into the second coolant chamber 130 may be prevented from leaking to the outside by the second O-ring 132.

FIG. 5 is a cross-sectional view of the coolant block according to an embodiment.

As shown in FIG. 5, the first coolant chamber 120 may be divided by a first partition wall 124 into an upper coolant chamber and a lower coolant chamber. In one example, the first partition wall 124 may not extend entirely between opposing sidewalls of the first coolant chamber 120, such that a gap, or communication hole, exists between one sidewall of the first coolant chamber 120 and one end of first partition wall 124. In this example, the flow of coolant flows from the first inflow flow path 140 into the upper coolant chamber, around the first partition wall 124 (i.e., through the communication hole) and into the lower coolant chamber towards the first discharge flow path 150.

The first coolant chamber 120 and the second coolant chamber 130 may be divided by a second partition wall 126. In one example, a cross-section of the second partition wall 126 may be formed in a zigzag shape. Because the cross-section of the second partition wall 126 is formed in the zigzag shape, heat exchange between the coolant circulating in the first coolant chamber 120 and the coolant circulating in the second coolant chamber 130 may be easily performed.

Referring back to FIG. 4, the plurality of flow paths formed in the block housing 110 may include a first inflow flow path 140, a first discharge flow path 150, a second inflow flow path 170, a second discharge flow path 180, an expansion flow path 160, and a connection flow path 190. Hereinafter, an inlet and an outlet may be described based on a flow direction of the coolant. Also, the terms “left surface,” “right surface,” and “upper surface” are spatially relative terms that merely refer to the view as shown in FIGS. 4 and 5 and are not intended to be limiting.

As shown in FIGS. 4 and 5, the first inflow flow path 140 may allow the coolant inflowing from the outside of the block housing 110 to flow into the first coolant chamber 120. In an embodiment, the first inflow flow path 140 may fluidly connect the condenser 20 and the first coolant chamber 120. In other words, an inlet of the first inflow flow path 140 may be formed on a left surface of the block housing 110, and an outlet of the first inflow flow path 140 may be fluidly connected to the first coolant chamber 120.

The first discharge flow path 150 may fluidly connect the first coolant chamber 120 and the expansion valve 30. In other words, an inlet of the first discharge flow path 150 may be fluidly connected to the first coolant chamber 120, and an outlet of the first discharge flow path 150 may be fluidly connected to the expansion valve 30.

The expansion flow path 160 may allow a gaseous coolant expanded in the expansion valve 30 to flow to the outside of the block housing 110. In an embodiment, the expansion flow path 160 may fluidly connect the expansion valve 30 and the evaporator 40. In other words, an inlet of the expansion flow path 160 may be fluidly connected to the expansion valve 30, and an outlet of the expansion flow path 160 may be formed on a right surface of the block housing 110.

The second inflow flow path 170 may allow the coolant inflowing from the outside of the block housing 110 to flow into the second coolant chamber 130. In an embodiment, the second inflow flow path 170 may fluidly connect the evaporator 40 and the second coolant chamber 130. In other words, an inlet of the second inflow flow path 170 may be formed on a right surface of the block housing 110, and an outlet of the second inflow flow path 170 may be fluidly connected to the second coolant chamber 130.

The second discharge flow path 180 may allow the coolant temporarily stored in the second coolant chamber 130 to flow to the outside of the block housing 110. In an embodiment, the second discharge flow path 180 may fluidly connect the second coolant chamber 130 and the compressor 10. In other words, an inlet of the second discharge flow path 180 may be fluidly connected to the second coolant chamber 130, and an outlet of the second discharge flow path 180 may be formed on an upper surface of the block housing 110.

The connection flow path 190 may allow the coolant inflowing into block housing 110 to flow to the outside of the block housing 110. In an embodiment, the connection flow path 190 may fluidly connect the compressor 10 and the condenser 20. In other words, an inlet of the connection flow path 190 may be formed on an upper surface of the block housing 110, and an outlet of the connection flow path 190 may be formed on a left surface of the block housing 110.

In an embodiment, the compressor 10 may be provided at an upper portion of the block housing 110, the condenser 20 may be provided at a left side of the block housing 110, and the evaporator 40 may be provided at a right side of the block housing 110.

The compressor 10 may be fluidly connected to the outlet of the second discharge flow path 180 and the inlet of the connection flow path 190 at the upper portion of the block housing 110. The condenser 20 may be fluidly connected to the outlet of the connection flow path 190 and the inlet of the first inflow flow path 140 at a left side of the block housing 110. The evaporator 40 may be fluidly connected to the outlet of the expansion flow path 160 and the inlet of the second inflow flow path 170 at a right side of the block housing 110.

Hereinafter, when the compressor 10, the condenser 20, and the evaporator 40 are included in the coolant block 100 according to an embodiment to constitute the air conditioner, a flow of the coolant is described.

The coolant compressed in the compressor 10 may pass through the connection flow path 190, the condenser 20, the first inflow flow path 140, the first coolant chamber 120, the first discharge flow path 150, the expansion valve 30, the expansion flow path 160, the evaporator 40, the second inflow flow path 170, the second coolant chamber 130, and the second discharge flow path 180 to be circulated back to the compressor 10.

In this process, while the coolant stored in the first coolant chamber 120 is heat-exchanged with a low-temperature coolant flowing through the second coolant chamber 130, a gaseous coolant and a liquid coolant may be separated, and moisture (or the like) included in the coolant may be removed. Accordingly, only the liquid coolant may be supplied to the expansion valve 30. For example, the first coolant chamber 120 may function as a receiver dryer. The second coolant chamber 130 may function as a heat exchanger.

Hereinafter, an air conditioner including a coolant block according to another embodiment is described in detail with reference to the accompanying drawings.

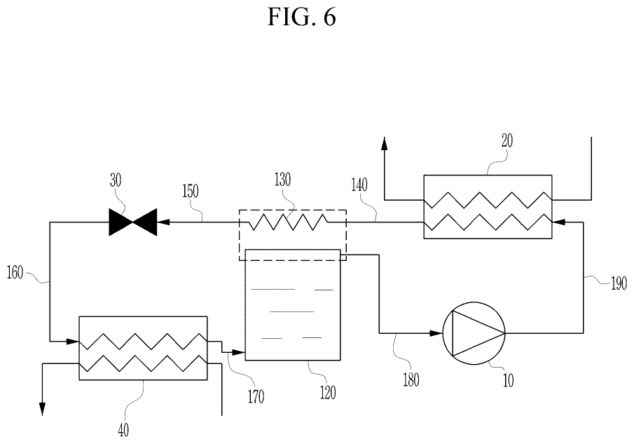

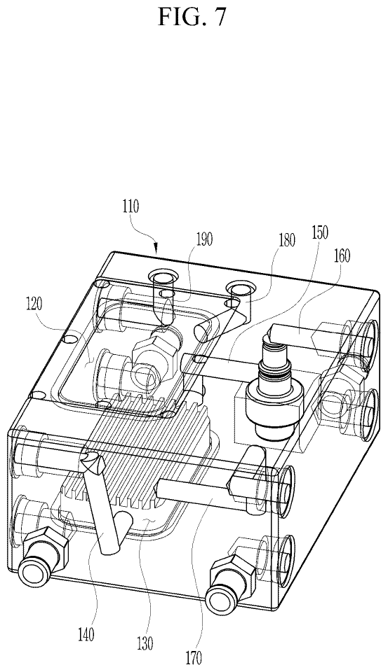

FIG. 6 is a circuit diagram showing a configuration of the air conditioner to which the coolant block is applied according to another embodiment. FIG. 7 is a perspective view showing a configuration of the coolant block according to another embodiment.

A difference between the embodiment shown in FIG. 6 and FIG. 7 and the embodiment shown in FIGS. 1-5 may be a connection relationship between a plurality of connection flow paths 190 disposed in a first coolant chamber 120 and a second coolant chamber 130. Hereinafter, a portion in which the embodiment shown in FIG. 6 and FIG. 7 is different from the embodiment shown in FIGS. 1-5 is mainly described.

A plurality of flow paths formed in a block housing 110 may include a first inflow flow path 140, a first discharge flow path 150, a second inflow flow path 170, a second discharge flow path 180, an expansion flow path 160, and a connection flow path 190.

The first inflow flow path 140 may allow a coolant inflowing from the outside of the block housing 110 to flow in the second coolant chamber 130. In an embodiment, the first inflow flow path 140 may fluidly connect a condenser 20 and the second coolant chamber 130. In other words, an inlet of the first inflow flow path 140 may be formed on a left surface of the block housing 110, and an outlet of the first inflow flow path 140 may be fluidly connected to the second coolant chamber 130.

The first discharge flow path 150 may fluidly connect the second coolant chamber 130 and an expansion valve 30. In other words, an inlet of the first discharge flow path 150 may be fluidly connected to the second coolant chamber 130, and an outlet of the first discharge flow path 150 may be fluidly connected to the expansion valve 30.

The expansion flow path 160 may allow a gaseous coolant expanded in the expansion valve 30 to flow to the outside of the block housing 110. In an embodiment, the expansion flow path 160 may fluidly connect the expansion valve 30 and an evaporator 40. In other words, an inlet of the expansion flow path 160 may be fluidly connected to the expansion valve 30, and an outlet of the expansion flow path 160 may be formed on a right surface of the block housing 110.

The second inflow flow path 170 may allow the coolant inflowing from the outside of the block housing 110 to flow into the first coolant chamber 120. In an embodiment, the second inflow flow path 170 may fluidly connect the evaporator 40 and the first coolant chamber 120. In other words, an inlet of the second inflow flow path 170 may be formed on a right surface of the block housing 110, and an outlet of the second inflow flow path 170 may be fluidly connected to the first coolant chamber 120.

The second discharge flow path 180 may allow the coolant temporarily stored in the first coolant chamber 120 to flow to the outside of the block housing 110. In an embodiment, the second discharge flow path 180 may fluidly connect the first coolant chamber 120 and a compressor 10. In other words, an inlet of the second discharge flow path 180 may be fluidly connected to the first coolant chamber 120, and an outlet of the second discharge flow path 180 may be formed on an upper surface of the block housing 110.

The connection flow path 190 may allow the coolant inflowing into block housing 110 to flow to the outside of the block housing 110. In an embodiment, the connection flow path 190 may fluidly connect the compressor 10 and the condenser 20. In other words, an inlet of the connection flow path 190 may be formed on an upper surface of the block housing 110, and an outlet of the connection flow path 190 may be formed on a left surface of the block housing 110.

In an embodiment, the compressor 10 may be provided at an upper portion of the block housing 110, the condenser 20 may be provided at a left side of the block housing 110, and the evaporator 40 may be provided at a right side of the block housing 110.

The compressor 10 may be fluidly connected to the outlet of the second discharge flow path 180 and the inlet of the connection flow path 190 at an upper portion of the block housing 110. The condenser 20 may be fluidly connected to the outlet of the connection flow path 190 and the inlet of the first inflow flow path 140 at a left side of the block housing 110. The evaporator 40 may be fluidly connected to the outlet of the expansion flow path 160 and the inlet of the second inflow flow path 170 at a right side of the block housing 110.

Hereinafter, when the compressor 10, the condenser 20, and the evaporator 40 are included in a coolant block 100 according to an embodiment to constitute the air conditioner, a flow of the coolant is described.

The coolant compressed in the compressor 10 may pass through the connection flow path 190, the condenser 20, the first inflow flow path 140, the second coolant chamber 130, the first discharge flow path 150, the expansion valve 30, the expansion flow path 160, the evaporator 40, the second inflow flow path 170, the first coolant chamber 120, and the second discharge flow path 180 to be circulated back to the compressor 10.

In this process, while the coolant stored in the first coolant chamber 120 is heat-exchanged with a high-temperature coolant flowing through the second coolant chamber 130, a liquid coolant that is not evaporated in the evaporator 40 may be phase-transformed into a gaseous coolant. Accordingly, only the gaseous coolant may be supplied to the compressor 10. For example, the first coolant chamber 120 may function as an accumulator. The second coolant chamber 130 may function as a heat exchanger.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

### Description of Symbols

10: compressor
20: condenser
30: expansion valve
40: evaporator
100: coolant block
110: block housing
120: first coolant chamber
121: first cover
122: first O-ring
124: first partition wall
126: second partition wall
130: second coolant chamber
131: second cover
132: second O-ring
140: first inflow flow path
150: first discharge flow path
160: expansion flow path
170: second inflow flow path
180: second discharge flow path
190: connection flow path

What is claimed is:

1. An air conditioner comprising a coolant block,
wherein the coolant block comprises:
a block housing;
a first coolant chamber formed in the block housing;
a second coolant chamber formed in the block housing and disposed adjacent to the first coolant chamber;
a first inflow flow path formed in the block housing and fluidly connected to the first coolant chamber;
a first discharge flow path formed in the block housing and fluidly connected to the first coolant chamber;
a second inflow flow path formed in the block housing and fluidly connected to the second coolant chamber;
a second discharge flow path formed in the block housing and fluidly connected to the second coolant chamber;
an expansion valve provided in the block housing and fluidly connected to the first discharge flow path;
an expansion flow path formed in the block housing through which a coolant expanded in the expansion valve flows; and
a connection flow path formed in the block housing fluidly connecting a compressor and a condenser.

2. The air conditioner of claim 1, wherein an inlet of the connection flow path and an outlet of the second discharge flow path are formed on a first surface of the block housing, an outlet of the expansion flow path and an inlet of the second inflow flow path are formed on a second surface of the block housing, and an inlet of the first inflow flow path and an outlet of the connection flow path are formed on a third surface of the block housing.

3. The air conditioner of claim 2, further comprising the compressor fluidly connected to the inlet of the connection flow path and the outlet of the second discharge flow path, wherein the compressor is provided on the first surface of the block housing.

4. The air conditioner of claim 2, further comprising the condenser fluidly connected to the inlet of the first inflow flow path and the outlet of the connection flow path, wherein the condenser is provided on the third surface of the block housing.

5. The air conditioner of claim 2, further comprising an evaporator fluidly connected to the outlet of the expansion flow path and the inlet of the second inflow flow path, wherein the evaporator is provided on the second surface of the block housing.

6. The air conditioner of claim 2, wherein a coolant stored in the first coolant chamber is configured to be heat-exchanged with a low-temperature coolant flowing through the second coolant chamber, and wherein the first coolant chamber is configured to function as a receiver dryer that supplies only a liquid coolant to the expansion valve.

7. The air conditioner of claim 1, further comprising:
a first partition wall that divides the first coolant chamber; and
a communication hole formed in the first partition wall.

8. The air conditioner of claim 7, wherein the first coolant chamber and the second coolant chamber are divided by a second partition wall.

9. The air conditioner of claim 8, wherein a cross-section of the second partition wall is zigzag shaped.

10. The air conditioner of claim 1, further comprising:
a first cover that covers an open surface of the first coolant chamber; and
a second cover that covers an open surface of the second coolant chamber.

11. The air conditioner of claim 10, further comprising:
a first O-ring provided between the first cover and the block housing; and
a second O-ring provided between the second cover and the block housing.

12. The air conditioner of claim 1, wherein an inlet of the connection flow path and an outlet of the second discharge flow path are formed on a first surface of the block housing, an outlet of the connection flow path and an inlet of the first inflow flow path are formed on a second surface of the block housing, and an outlet of the expansion flow path and an inlet of the second inflow flow path are formed on a third surface of the block housing.

13. The air conditioner of claim 12, further comprising the compressor fluidly connected to the inlet of the connection flow path and the outlet of the second discharge flow path, wherein the compressor is provided on the first surface of the block housing.

14. The air conditioner of claim 12, further comprising the condenser fluidly connected to the outlet of the connection flow path and the inlet of the first inflow flow path, wherein the condenser is provided on the second surface of the block housing.

15. The air conditioner of claim 12, further comprising an evaporator fluidly connected to the outlet of the expansion flow path and the inlet of the second inflow flow path, wherein the evaporator is provided on the third surface of the block housing.

16. The air conditioner of claim 12, wherein a coolant stored in the first coolant chamber is configured to be heat-exchanged with a high-temperature coolant flowing through the second coolant chamber, and wherein the first coolant chamber is configured to function as an accumulator that supplies only a gaseous coolant to the compressor.

17. A coolant block of an air conditioner, the coolant block comprising:
a block housing;
a first coolant chamber and a second coolant chamber formed in the block housing, wherein the second coolant chamber is disposed adjacent to the first coolant chamber;
a first inflow flow path and a first discharge flow path formed in the block housing and fluidly connected to the first coolant chamber;
a second inflow flow path and second discharge flow path formed in the block housing and fluidly connected to the second coolant chamber;
an expansion valve provided in the block housing and fluidly connected to the first discharge flow path;
an expansion flow path formed in the block housing through which a coolant expanded in the expansion valve flows;
a connection flow path formed in the block housing that fluidly connects a compressor and a condenser; and
an evaporator formed in the block housing and fluidly connected to an inlet of the connection flow path and an outlet of the second discharge flow path.

18. The coolant block of claim 17, wherein the compressor, the condenser, the expansion valve, and the evaporator are sequentially disposed along a flow direction of the coolant.

19. The coolant block of claim 17, wherein the coolant discharged by driving of the compressor is circulated back to the compressor through the condenser, the expansion valve, and the evaporator.

20. The coolant block of claim 18, wherein heat exchange between the coolant and indoor air of a vehicle is performed through the evaporator, such that the air conditioner is configured to cool an inside of the vehicle.
